(19) United States
(12) Patent Application Publication
(10) Pub. No.: US 2004/0177553 A1
(43) Pub. Date: Sep. 16, 2004

(54) Plant container with selectively sealable drainage hole

(76) Inventor: Kenneth A. Harbaugh, Douglasville, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/389,362

(22) Filed: Mar. 14, 2003

(51) Int. Cl. A01G 9/02

(52) U.S. Cl. 47/65.6

(57) ABSTRACT

A plant container has a threaded drainage hole provided in the base of the container adapted to receive a threaded drain plug. When a drainage hole is needed, the plug is removed. When a drainage hole is not needed, the plug is left in place.

### TECHNICAL FIELD

The present invention relates generally to plant containers and relates more specifically to plant containers with drainage holes.

### BACKGROUND OF THE INVENTION

Plant containers for potted plants are well known. Preferably such containers have drainage holes in the bottom of the container to permit water to drain out in the event of over-watering. Such drainage holes prevent the roots of the plant from sitting in water-saturated soil for prolonged periods of time and developing, among other things, root rot.

Plant containers with drainage holes are suitable for outdoor use, or for indoor use where the container can be situated on another, shallower container into which the excess water can drain away from the primary container. However, where the container is to be used by itself on fine wood floors or on carpets, for example, drainage holes are not an option.

Suppliers of plant containers are left with two options: either supply containers both with and without drainage holes, or supply only containers without drainage holes and leave it to the purchaser to provide the drainage hole where needed, either with or without the benefit of pre-marked drill locations or pre-scored knockouts. The former option suffers the disadvantage of having to maintain double inventory, while the latter option suffers the disadvantage of customer inconvenience at having to put the drainage hole into the container themselves, where in fact the customer may lack the necessary tools, skills, or desire to perform the task.

### SUMMARY OF THE INVENTION

Stated generally, the present invention comprises a plant container having a threaded drainage hole provided in the base of the container adapted to receive a threaded drain plug. When a drainage hole is needed, the plug is removed. When a drainage hole is not needed, the plug is left in place (or replaced, as the case might be). The operation of screwing the plug into or out of the threaded drainage hole can be performed easily by anyone without any tools or special skills.

Thus it is an object of the present invention to provide a plant container that can either be made available with or without a drainage hole, without having to maintain an inventory of two different types of plant containers.

It is another object of the present invention to provide a plant container that can be converted between one without a drainage hole and one with a drainage hole by a purchaser without any tools or special skills.

Other objects, features, and advantages of the present invention will become apparent upon reading the following specification, when taken in conjunction with the drawings and the appended claims.

### BRIEF DESCRIPTION OF THE DRAWINGS

FIG. 1 is a cross-sectional view of a plant container according to a disclosed embodiment of the present invention.

FIG. 2 is an enlargement of the section identified by the circle 2 in FIG. 1 showing a drain plug and threaded drainage hole.

FIG. 3 is another view of the drain plug and receptacle of FIG. 2 showing the drain plug seated in the threaded drainage hole.

FIG. 4 is a cross-sectional view showing a first step in the assembly of a receptacle into a plant container.

FIG. 5 is a top view of the receptacle of FIG. 4 prior to assembly into the plant container.

FIG. 6 is a cross-sectional view showing a second step in the assembly of the receptacle into the plant container.

FIG. 7 is a cross-sectional view following a third step in the assembly of the receptacle into the plant container.

FIG. 8 is an orthogonal view of an alternate embodiment of a drainage plug.

### DETAILED DESCRIPTION OF THE DISCLOSED EMBODIMENT

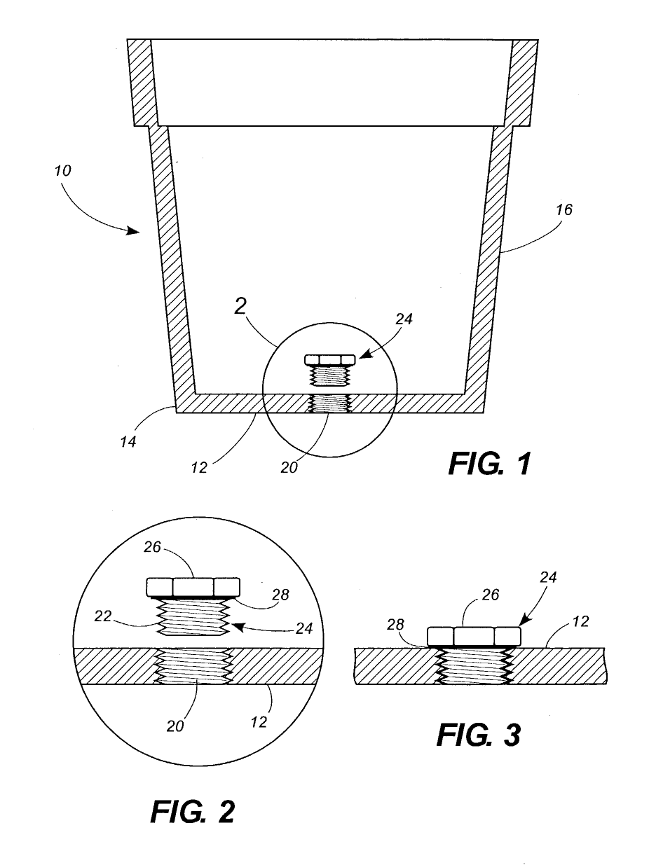

Referring now to the drawings, in which like numerals indicate like elements throughout the several views, FIG. 1 is a cross-central view of a plant container can according to a disclosed embodiment of the present invention. The plant container 10 comprises a base 12 having peripheral edges 14. Side walls 16 extend generally vertically upward from the peripheral edges 14 of the base 12. Together the base 12 and side walls 16 define a fluid-tight container of conventional construction. The container 10 can be molded from fiberglass, foam, ceramics, or other suitable material.

The base 12 has a drainage hole 20 formed in a central portion thereof. The drainage hole 20 is threaded and is adapted to receive the threaded shank 22 of a drain plug 24. The drain plug 24 has an enlarged head portion 26 at its upper end. A resilient annular washer 28 is located around the upper end of the shank 22 immediately below the head 26.

As used herein, the container will be said to be defined by “side walls” and a “base.” However, there may be instances in which it is difficult to discern where the side walls end and where the base begins, for example, in the case of a container having a rounded or bowl shape. For purposes of this document, it is not important where the side walls begin and where the base begins, so long as the side walls and base together define a container, and so long as the base includes the portion of the container in which the drainage hole is formed.

To use the container 10 in an application in which a drainage hole is desirable, for example, an outdoor application, the user simply unscrews the drain plug 24 from the drainage hole 20 prior to putting a plant in the container, leaving the drainage hole vacant. Potting soil and a plant are then placed in the container in the usual fashion. Thereafter, in the event of excess water entering the container, whether by over-watering or by heavy rainfall, excess water will drain out of the container through the drainage hole 20.

To use the container in an application in which a drainage hole would be disadvantageous, for example, an indoor application where the container would be placed on fine flooring, rugs, or carpets, the user inserts the drain plug 24 into the drainage hole 20 and screws the plug tightly into the hole. As the plug is tightened, the resilient washer 28 is compressed between the head 26 and the base 12 to seal the opening around the drainage hole 20. Potting soil and a plant are then placed in the container in the usual fashion. Thereafter, water is prevented from exiting through the drainage hole 20 by the drain plug 24.

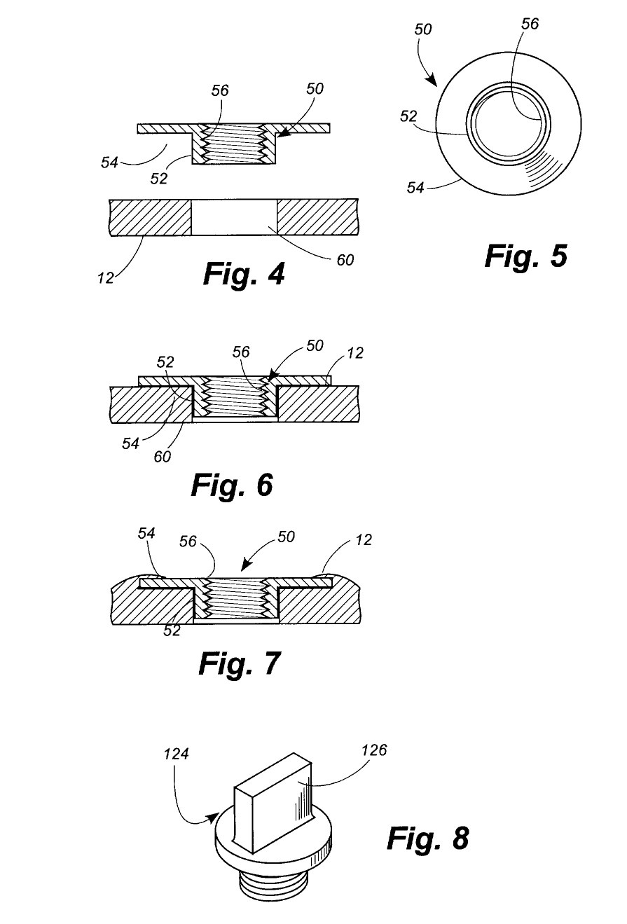

Depending upon the material from which the container 10 is fabricated, the threaded drainage hole can be formed directly in the base 12 of the container, such as by tapping the hole. However, an advantageous way of providing a threaded drainage hole 20 in the base 12 of a container 10 is illustrated in FIGS. 4-7. Referring first to FIGS. 4 and 5, a fitting 50 comprises a cylindrical central portion 52 and an annular flange 54 extending radially outward from the upper portion of the cylinder. A threaded bore 56 is formed in the center of the cylinder. To accommodate the fitting 50 in the base 12 of the cylinder, a circular hole 60 sufficiently large to accommodate the cylindrical central portion 52 of the fitting is formed in the base.

The fitting 50 is then positioned with the cylindrical central portion 52 within the hole 60, and the annular flange 54 bearing against the upper surface of the base 12, as shown in FIG. 6. Bonding materials appropriate to the construction of the container 10 are then applied over the edges of the annular flange 54. For example, in the case of a molded fiberglass container, a mixture of fiberglass and resin is applied over the periphery of the annular flange 54 of the fitting 50. The resulting structure is depicted in FIG. 7. The threaded bore 56 in the fitting 50 now serves as the drainage hole of the container and receives the drain plug 24. Operation of the device is as previously described.

Preferably, though not necessarily, the fitting 50 will be formed from the same material as the container 10 into which it is being installed. For example, in the case of a molded fiberglass container in which the fitting is molded from fiberglass, adding fiberglass and resin to fill in the recesses of the hole 60 above and below the annular flange 54 of the fitting 50 will not only bond and form a unitary structure with the container 10 but will also bond and form a unitary structure with the fitting 50.

FIG. 8 is an alternate embodiment of a drain plug 124 having an upwardly extending flange 126 to facilitate grasping of the drain plug by a user between the fingers and rotating of the plug without a wrench.

Finally, it will be understood that the preferred embodiment has been disclosed by way of example, and that other modifications may occur to those skilled in the art without departing from the scope and spirit of the appended claims.

What is claimed is:

1. A plant container, comprising:
a base having peripheral edges;
side walls extending upward from said peripheral edges of said base;
a threaded bore defining an opening in said base; and
a threaded plug configured to cooperatively engage said threaded bore to selectively close said opening in a watertight manner.

2. The plant container of claim 1, further comprising a fitting disposed within said base, said threaded bore being defined in said fitting.

3. The plant container of claim 1, wherein said base and said side walls are molded out of fiberglass.

4. The plant container of claim 3, further comprising a fiberglass fitting disposed within said base, said threaded bore being defined in said fitting.

5. The plant container of claim 1, wherein said base and said side walls are molded out of foam.

6. The plant container of claim 5, further comprising a foam fitting disposed within said base, said threaded bore being defined in said fitting.

7. The plant container of claim 1, wherein said base and said side walls are molded out of ceramics.

8. The plant container of claim 5, further comprising a ceramics fitting disposed within said base, said threaded bore being defined in said fitting.

9. A method of manufacturing a plant container, comprising:
forming a hole in the base of a container, said hole having a top and a bottom;
inserting the body of a fitting in said hole, said fitting having a flange at the upper end of said body configured to engage said base of said container so as to prevent passage thereof through said hole in said base of said container; said fitting having a threaded bore formed therethrough; and
overlaying at least a portion of said flange with a bonding material so as to bond said flange to said base of said container, said fitting thereby being retained within said base of said container;
whereby said threaded bore of said fitting comprises a drain hole in the base of said container.

10. The method of claim 9, wherein said container is molded fiberglass, and wherein said bonding material comprises fiberglass and resin.

11. The method of claim 10, wherein said fitting comprises a molded fiberglass fitting.
